(19) United States
(12) Patent Application Publication
(10) Pub. No.: US 2024/0090047 A1
(43) Pub. Date: Mar. 14, 2024

(54) TECHNIQUES FOR MANAGING THE CELLULAR CONNECTIVITY STATE OF A SUBMERGED WIRELESS DEVICE

(71) Applicant: Apple Inc., Cupertino, CA (US)

(72) Inventors: Ajoy K. SINGH, Milpitas, CA (US); Ajay kumar S. GUPTA, Sunnyvale, CA (US); Prathyusha PALLERLAMUDI, San Jose, CA (US)

(21) Appl. No.: 18/450,360

(22) Filed: Aug. 15, 2023

Related U.S. Application Data
(60) Provisional application No. 63/375,531, filed on Sep. 13, 2022.

(51) Int. Cl. H04W 76/10; H04B 13/02

(52) U.S. Cl. CPC H04W 76/10; H04B 13/02

(57) ABSTRACT

This Application sets forth techniques for managing the cellular connectivity state of a submerged wireless device. The wireless device can include sensors that analyze environmental conditions to determine when the wireless device is (or is not) submerged underwater as well as at what depth the wireless device is submerged underwater. The sensors can also determine different types of aquatic activity in which a user of the wireless device is currently engaged, such as swimming, snorkeling, free diving, and scuba diving. In turn, the wireless device can utilize this information to manage its cellular connectivity state in order to avoid wasteful consumptions of energy. In particular, the techniques enable the submerged wireless device to eliminate any existing cellular connection as well as connection reattempts so long as they are unlikely to succeed. Moreover, the techniques enable the wireless device to execute connection reattempts when they are appropriate and likely to succeed.

### CROSS-REFERENCE TO RELATED APPLICATIONS

The present application claims the benefit of U.S. Provisional Application No. 63/375,531, entitled “TECHNIQUES FOR MANAGING THE CELLULAR CONNECTIVITY STATE OF A SUBMERGED WIRELESS DEVICE,” filed Sep. 13, 2022, the content of which is incorporated by reference herein in its entirety for all purposes.

### FIELD

The described embodiments set forth techniques for managing the cellular connectivity state of a submerged wireless device. In particular, the techniques enable the submerged wireless device to eliminate any existing cellular connection as well as connection reattempts so long as they are unlikely to succeed (e.g., while the wireless device remains submerged). Moreover, the techniques enable the wireless device to execute connection reattempts when they are appropriate and likely to succeed (e.g., when the wireless device is no longer submerged).

### BACKGROUND

There is an ongoing interest in extending the battery life of wireless devices in order to be environmentally responsible as well as to provide an enhanced user experience. In particular, is desirable to reduce the amount of energy that wireless devices consume so that they require less overall energy to operate. In this regard, it can be beneficial to tweak the operational configurations of wireless devices so they do not perform unnecessary tasks that wastefully consume energy. Such reductions can provide a variety of benefits, including smaller battery capacities (thereby enabling smaller form factors), reduced charge cycle requirements, and extended battery life.

Wireless devices—particularly, wearables, cell phones, tablets, etc.—continue to grow in both popularity and overall sophistication. For example, some wearable devices, despite their typically small form factors, now include cellular radios that enable the wearable devices to transmit and receive information over cellular connections. In some cases, some wearable devices are waterproof (or water resistant) and enable the wearer to perform a variety of aquatic activities such as swimming, snorkeling, free diving, and even scuba diving without damaging the wearable device.

Although cellular wireless technologies have vastly improved over the years, they continue to suffer from a variety of connectivity constraints that pose challenges in common operating scenarios. Such connectivity constraints can arise, for example, when a wireless device is deep within a building, is surrounded by tall buildings, or is in an underground structure. Moreover, such connectivity constraints arise when a wireless device, such as a wearable device, is submerged underwater, which deteriorates cellular transmissions even at relatively shallow depths. Presently, when a wearable device is submerged and loses its cellular connection, it enters into network search mode and expends energy by continuously attempting to reattach to an available cellular base station. This scenario is unfortunate because such attempts are unlikely to succeed so long as the wireless device remains submerged and cellular connectivity is not possible.

In view of the foregoing considerations, there exists a need for a technique for managing the cellular connectivity state of a wireless device when it is submerged underwater.

### SUMMARY

This Application sets forth techniques for managing the cellular connectivity state of a submerged wireless device. In particular, the techniques enable the submerged wireless device to eliminate any existing cellular connection as well as connection reattempts so long they are unlikely to succeed (e.g., while the wireless device remains submerged). Moreover, the techniques enable the wireless device to execute connection reattempts when they are appropriate and likely to succeed (e.g., when the wireless device is no longer submerged).

One embodiment sets forth a method for managing a cellular connectivity state of a wireless device in relation to aquatic activity performed using the wireless device. According to some embodiments, the method is performed at the wireless device, and includes the steps of (1) determining that the wireless device is submerged underwater, (2) in response to determining that the wireless device satisfies a threshold depth: (i) starting a depth timer, where the wireless device: (a) terminates the depth timer whenever the wireless device no longer satisfies the threshold depth, and (b) restarts the depth timer whenever the wireless device satisfies the threshold depth after the depth timer is terminated, and (3) in response to identifying that the depth timer has lapsed: deactivating a baseband component of the wireless device to prevent the baseband component from attempting to establish a cellular connection.

The method further includes the steps of, subsequent to deactivating the baseband component: (4) determining that the wireless device is no longer submerged underwater, (5) starting a hysteresis timer, where the wireless device restarts the hysteresis timer whenever the wireless device becomes re-submerged underwater, and (6) in response to identifying that the hysteresis timer has lapsed: activating the baseband component of the wireless device to enable the baseband component to establish the cellular connection.

Other embodiments include a non-transitory computer readable medium configured to store instructions that, when executed by a processor included in a computing device, cause the computing device to implement the methods and techniques described in this disclosure. Yet other embodiments include hardware computing devices that include processors that can be configured to cause the hardware computing devices to implement the methods and techniques described in this disclosure.

Other aspects and advantages of the invention will become apparent from the following detailed description taken in conjunction with the accompanying drawings which illustrate, by way of example, the principles of the described embodiments.

This Summary is provided merely for purposes of summarizing some example embodiments so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a block diagram of different components of an exemplary system configured to implement the various techniques described herein, according to some embodiments.

FIG. 2 illustrates a block diagram of a more detailed view of particular components of a wireless device illustrated in FIG. 1, according to some embodiments.

FIG. 3 illustrates a conceptual diagram of a manner in which sensors of the wireless device of FIGS. 1 and 2 can be configured to analyze environmental conditions, according to some embodiments.

FIGS. 4A and 4B illustrate a method for a technique for modifying the cellular connectivity state of a wireless device when it is submerged underwater, according to some embodiments.

FIG. 5 sets forth a conceptual diagram of an example scenario that involves a wireless device undergoing cellular connectivity state modifications in relation to aquatic activity in which a user of the wireless device is engaging, according to some embodiments.

FIG. 6 illustrates a conceptual diagram of exemplary user interfaces that can be displayed by a wireless device that is undergoing cellular connectivity state modifications in relation to aquatic activity in which a user of the wireless device is engaging, according to some embodiments.

FIG. 7 illustrates a block diagram of exemplary elements of a mobile wireless device, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description, and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

The described embodiments set forth techniques for managing the cellular connectivity state of a submerged wireless device. In particular, the techniques enable the submerged wireless device to eliminate any existing cellular connection as well as connection reattempts so long as they are unlikely to succeed (e.g., while the wireless device remains submerged). Moreover, the techniques enable the wireless device to execute connection reattempts when they are appropriate and likely to succeed (e.g., when the wireless device is no longer submerged).

According to some embodiments, the wireless device can include one or more sensors that are designed to analyze environmental conditions to effectively determine when the wireless device is (or is not) submerged underwater, at what depth the wireless device is submerged underwater, and so on. The sensors can also enable the wireless device to effectively determine different types of aquatic activity in which a user of the wireless device is currently engaged, such as swimming, snorkeling, free diving, scuba diving, and so on. In turn, the wireless device can utilize this information to manage its cellular connectivity state in order to avoid wasteful consumptions of energy.

In particular, the wireless device can identify scenarios in which energy savings can be achieved, which can include, for example, the wireless device being submerged underwater at least at a threshold depth and for at least a threshold amount of time (where a cellular connection is physically impossible due to the interference caused by water). In turn, the wireless device can deactivate its baseband component such that (1) an existing cellular connection (if any) is eliminated, and (2) the baseband component will not reattempt to establish a cellular connection until the baseband component is reactivated. The wireless device can also identify scenarios in which it is appropriate to reactivate the baseband component. Such a scenario can include, for example, when the wireless device has resurfaced and remained at the surface for at least a threshold period of time (where the physical interferences have been eliminated). In turn, the wireless device can reactivate the baseband component so that it can reattempt to establish a cellular connection.

Additionally, the wireless device can consider the type of aquatic activity that is taking place when performing the foregoing (or other) techniques. In particular, the aquatic activity can influence the values of the depth thresholds and different timers that guide the deactivation/reactivation of the baseband component. The wireless device can also take the aquatic activity into consideration alongside of other conditions that arise. For example, when the wireless device determines that it is no longer submerged underwater—but that surface swimming activity is taking place (e.g., swimming back to a boat after a scuba dive)—the wireless device may choose to reactivate the baseband only after it determines the swimming activity has ended. These techniques provide considerable benefits in that they cause the wireless device to automatically deactivate/reactivate the baseband component in accordance with both (1) physical limitations that arise with respect to cellular connections, and (2) user activity in which the user is (or is not) likely to expect/utilize a cellular connection.

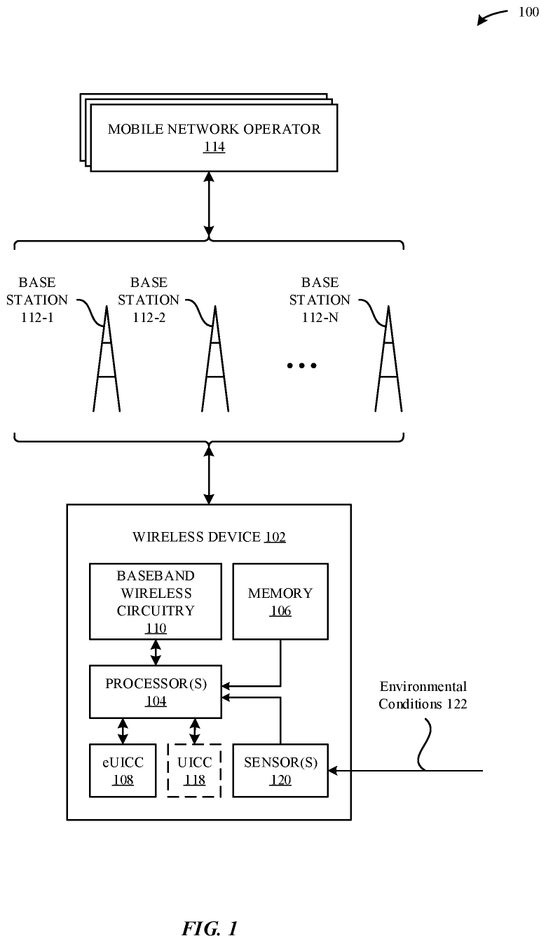

These and other embodiments are discussed below with reference to FIGS. 1-7; however, those skilled in the art will readily appreciate that the detailed description given herein with respect to these figures is for explanatory purposes only and should not be construed as limiting.

FIG. 1 illustrates a block diagram of different components of a system 100 that is configured to implement the various techniques described herein, according to some embodiments. More specifically, FIG. 1 illustrates a high-level overview of the system 100, which, as shown, includes a wireless device 102, which can also be referred to as a device, a wireless device, a mobile device, a user equipment (UE) and the like, a group of base stations 112-1 to 112-N that are managed by different Mobile Network Operators (MNOs) 114. Additional MNO infrastructure servers, such as used for account management and billing are not shown. The wireless device 102 can represent a mobile computing device (e.g., an iPhone®, an iPad®, an Apple Watch by Apple®, etc.), the base stations 112-1 to 112-n can represent cellular wireless network entities including evolved NodeBs (eNodeB s or eNBs) and/or next generation NodeBs (gNodeBs or gNB) that are configured to communicate with the wireless device 102, and the MNOs 114 can represent different wireless service providers that provide specific cellular wireless services (e.g., voice and data) to which the wireless device 102 can subscribe, such as via a subscription account for a user of the wireless device 102.

As shown in FIG. 1, the wireless device 102 can include processing circuitry, which can include one or more processor(s) 104 and a memory 106, at least one embedded Universal Integrated Circuit Card (eUICC) 108, and a baseband wireless circuitry 110 used for transmission and reception of cellular wireless radio frequency signals. The baseband wireless circuitry 110 can include analog hardware components, such as antennas and amplifiers, as well as digital processing components, such as signal processors (and/or general/limited purpose processors) and associated memory. In some embodiments, the wireless device 102 includes one or more physical UICCs 118, also referred to as Subscriber Identity Module (SIM) cards, in addition to or substituting for the eUICC 108. The components of the wireless device 102 work together to enable the wireless device 102 to provide useful features to a user of the wireless device 102, such as cellular wireless network access, non-cellular wireless network access, localized computing, location-based services, and Internet connectivity. The eUICC 108 can be configured to store multiple electronic SIM (eSIM) profiles for accessing cellular wireless services provided by different MNOs 114 by connecting to their respective cellular wireless networks through base stations 112-1 to 112-N. For example, the eUICC 108 can be configured to store and manage one or more eSIM profiles for one or more MNOs 114 for different subscriptions to which the wireless device 102 is associated. To be able to access services provided by an MNO, an eSIM profile can be reserved for subsequent download and installation to the eUICC 108.

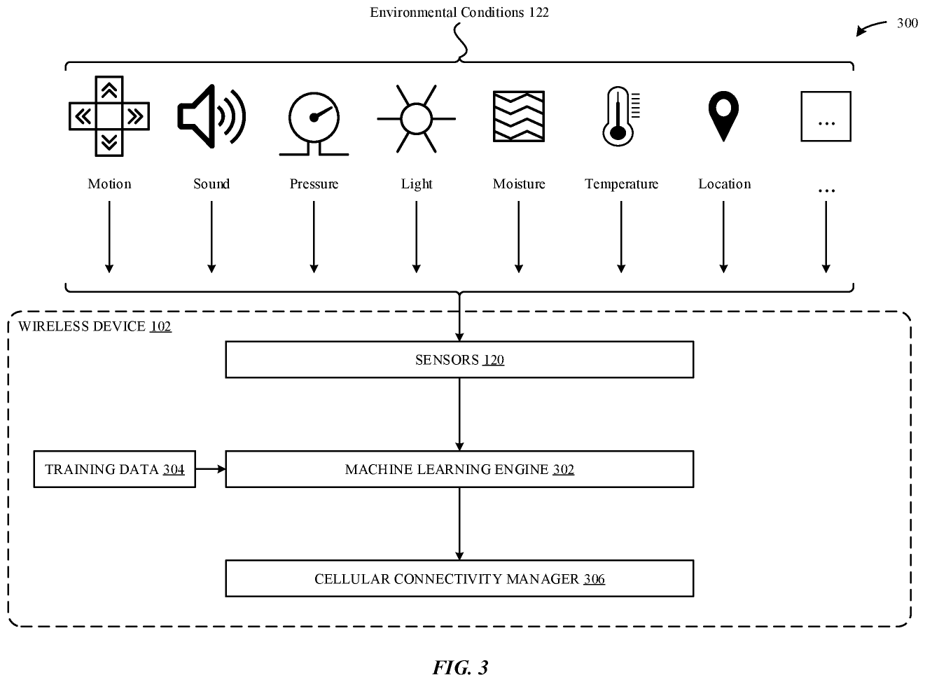

Additionally, and as shown in FIG. 1, the wireless device 102 can include one or more sensors 120 that are capable of analyzing environmental conditions 122. In particular, the sensors can represent hardware and/or software components that enable the wireless device 102 to detect and process the environmental conditions 122 in order to provide the functionalities described herein. For example, the sensors 120 can enable the wireless device 102 to accurately determine when the wireless device 102 is (or is not) submerged underwater, at what depth the wireless device is submerged underwater, and so on. The sensors 120 can also enable the wireless device 102 to accurately determine different types of aquatic activity in which a user of the wireless device 102 is currently engaged, such as swimming, snorkeling, free diving, scuba diving, and so on. In turn, the wireless device 102 can utilize this information to manage its cellular connectivity state in order to avoid wasteful consumptions of energy. A more detailed explanation of the sensors 120 and the environmental conditions 122 is provided below in conjunction with FIG. 3.

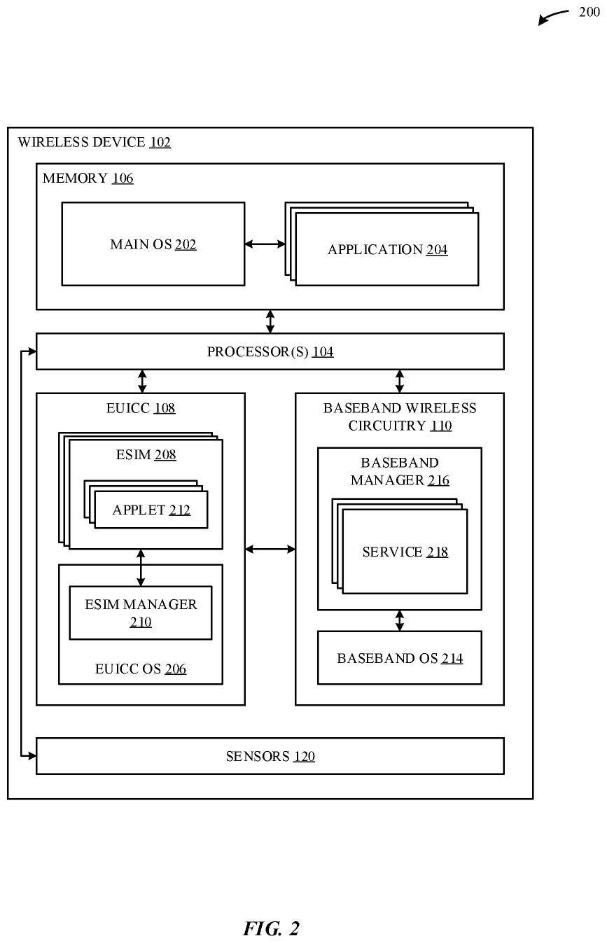

FIG. 2 illustrates a block diagram of a more detailed view 200 of particular components of the wireless device 102 of FIG. 1, according to some embodiments. As shown in FIG. 2, the processor(s) 104, in conjunction with memory 106, can implement a main operating system (OS) 202 that is configured to execute applications 204 (e.g., native OS applications and user applications). As also shown in FIG. 2, the eUICC 108 can be configured to implement an eUICC OS 206 that is configured to manage hardware resources of the eUICC 108 (e.g., a processor and a memory embedded in the eUICC 108). The eUICC OS 206 can also be configured to manage eSIM profiles 208 that are stored by the eUICC 108, e.g., by downloading, installing, deleting, enabling, disabling, modifying, or otherwise performing management of the eSIM profiles 208 within the eUICC 108 and to provide baseband wireless circuitry 110 with access to the eSIM profiles 208 to provide access to wireless services for the wireless device 102. The eUICC 108 OS can include an eSIM profile manager 210, which can perform management functions for various eSIM profiles 208. According to the illustration shown in FIG. 2, each eSIM profile 208 can include a number of applets 212 that define the manner in which the eSIM profile 208 operates. For example, one or more of the applets 212, when implemented in conjunction with baseband wireless circuitry 110 and the eUICC 108, can be configured to enable the wireless device 102 to communicate with an MNO 114 and provide useful features (e.g., phone calls and internet access) to a user of the wireless device 102.

As also shown in FIG. 2, the baseband wireless circuitry 110 of the wireless device 102 can include a baseband OS 214 that is configured to manage hardware resources of the baseband wireless circuitry 110 (e.g., a processor, a memory, different radio components, etc.). According to some embodiments, the baseband wireless circuitry 110 can implement a baseband manager 216 that is configured to interface with the eUICC 108 to establish a secure channel with an MNO provisioning server and obtaining information (such as eSIM profile data) from the MNO provisioning server for purposes of managing eSIM profiles 208. The baseband manager 216 can be configured to implement services 218, which represents a collection of software modules that are instantiated by way of the various applets 212 of enabled eSIM profiles 208 that are included in the eUICC 108. For example, services 218 can be configured to manage different connections between the wireless device 102 and MNOs 114 according to the different eSIM profiles 208 that are enabled within the eUICC 108.

FIG. 3 illustrates a conceptual diagram 300 of a manner in which the sensors 120 of the wireless device 102 can be configured to analyze environmental conditions 122, according to some embodiments. As shown in FIG. 3, the sensors 120 can be configured to analyze various environmental conditions 122, such as motion, sound, pressure, light, moisture, temperature, location, and the like. It is noted that the environmental conditions 122 illustrated in FIG. 3 are merely exemplary and not meant to be limiting. On the contrary, any number of sensors 120—as well as any type—can be included in the wireless device 102 to analyze any environmental condition 122 without departing from the scope of this disclosure.

As previously discussed herein, each sensor 120 can represent hardware and/or software components implemented on the wireless device 102. According to some embodiments, each sensor 120 can be configured to analyze specific environmental conditions 122 and to output raw and/or processed information. For example, with respect to raw information, a sensor 120 designed to analyze motion can be configured to output acceleration information, orientation information, and the like, whereas a sensor 120 designed to analyze sound can be configured to output decibel information, frequency information, and the like. Continuing with the foregoing example—and, with respect to processed information—the motion sensors 120 can generate abstractions of the raw data in order to provide useful information, to reduce the processing burden on the machine learning engine 302, and so on. For example, a motion sensor 120 can determine, based on the raw data it collects, that a particular activity (e.g., walking, running, swimming, etc.) is taking place, and a sound sensor 120 can determine, based on the raw data it collects, that a particular activity (e.g., talking, exercising, etc.) is taking place as well. It is noted that the foregoing examples are not meant to be limiting, and that any number of sensors 120 can be configured to provide raw/processed information, at any level of granularity, without departing from the scope of this disclosure.

As shown in FIG. 3, the sensors 120 can be configured to output information (e.g., raw information, processed information, etc.) to a machine learning engine 302 that is implemented on the wireless device 102. According to some embodiments, the machine learning engine 302 can be configured based on training data 304 (gathered by other wireless devices placed into the same or similar aquatic scenarios described herein) that enables the machine learning engine 302 to generate useful information based on what is gathered by the sensors 120. Such useful information can include, for example, identifying when the wireless device 102 is (or is not) submerged underwater. Additionally, the useful information can include a type of aquatic activity in which a user of the wireless device 102 (and the wireless device 102 itself) is engaged, such as swimming, snorkeling, free diving, scuba diving, and the like. It is noted that the foregoing examples are not meant to be limiting, and that the machine learning engine 302 can be configured to generate any useful information—at any level of granularity—without departing from the scope of this disclosure. As described in greater detail below, such information can be utilized by the wireless device 102 to effectively determine when it is prudent to modify its cellular connectivity state with the goal of achieving energy savings.

According to some embodiments, the machine learning engine 302 can determine when the wireless device 102 is submerged underwater by analyzing one or more of motion information, sound information, pressure information, light information, moisture information, temperature information, location information, and the like. For example, machine learning engine 302 may determine that the wireless device 102 is submerged underwater when (1) the motion information indicates that the wireless device 102 is suspended in water (e.g., on its surface or under it), (2) the sound information (e.g., muddled noises, splashing, etc.) indicates that a user of the wireless device 102 is engaged in an aquatic activity, (3) the pressure information indicates that the wireless device 102 is at a particular depth underwater, (4) the light information indicates a particular intensity, hue, fluctuation pattern, etc., that suggests the wireless device 102 is submerged underwater, (5) the moisture information indicates a presence of water, (6) the temperature information indicates a sudden drop (or increase) in ambient temperature (that suggests the wireless device 102 has moved from air into water), and/or (7) the location information indicates that the wireless device 102 is located in a body of water. It is noted that the machine learning engine 302 is not required to analyze all of the foregoing information in order to accurately determine when the wireless device 102 is submerged underwater. On the contrary, the machine learning engine 302 may effectively determine when the wireless device 102 is submerged underwater by analyzing fewer/other environmental conditions 122 under the same/different considerations without departing from the scope of this disclosure.

Additionally, and according to some embodiments, the machine learning engine 302 can determine when the wireless device 102 is engaged in aquatic activity by analyzing one or more of motion information, sound information, pressure information, light information, moisture information, temperature information, location information, and the like. In one example, the machine learning engine 302 may determine that the user of the wireless device 102 (and the wireless device 102 itself) is engaged in a swimming activity when (1) the motion information reflects a particular swimming stroke (e.g., freestyle, breaststroke, backstroke, butterfly, etc.), (2) the sound, pressure, light, and/or temperature information indicates rapid fluctuations between being above water and below water (e.g., the user's arms repeatedly moving into and out of the water), and (3) the location information indicates that the wireless device 102 is located in a body of water.

In another example, the machine learning engine 302 may determine that the wireless device 102 (and the user thereof) is engaged in a scuba diving activity when (1) the motion information indicates a suspension in water combined with graceful upward/downward accelerations, (2) the sound, pressure, light, and/or temperature information indicates that the wireless device 102 has both entered into and remained underwater for an extended period of time, and (3) the location information indicates that the wireless device 102 is located in a body of water. Similar approaches may be used to identify other aquatic-based activities, such as free diving, snorkeling, and so on. It is noted that the machine learning engine 302 is not required to analyze all of the foregoing information in order to accurately determine diverse types of aquatic activity in which the user/wireless device 102 is engaged. On the contrary, the machine learning engine 302 may effectively determine when the user/wireless device 102 is engaged in aquatic activity by analyzing fewer/other environmental conditions 122 under the same/different considerations without departing from the scope of this disclosure.

It is noted that the foregoing environmental conditions 122, as well as the foregoing example manners in which they can be analyzed by the machine learning engine 302, are not meant to be limiting. On the contrary, the machine learning engine 302 can be configured to analyze any number of environmental conditions 122 in any fashion to effectively identify the different states of the wireless device 102 without departing from the scope of this disclosure. For example, the machine learning engine 302 may consider non-environmental conditions when performing its analyses. In one example, if a user of the wireless device 102 has granted the wireless device 102 permission to access the user's calendar information, then the wireless device 102 could analyze such calendar information to determine, at least in part, the different states of the wireless device 102 discussed herein. For example, if a calendar entry indicates a scuba diving outing from 3 PM-4 PM, and the current time is within that range, then the machine learning engine 302 could incorporate such information into making its determination.

In another example, if a user of the wireless device 102 has granted the wireless device 102 permission to analyze a user's current/past activities, then the wireless device 102 could analyze such information to determine, at least in part, the different states/activities discussed herein in which the user/wireless device 102 may be presently engaged. For example, the wireless device 102 could effectively determine that a user may be engaged in aquatic activity if the user has shown a strong pattern of such engagement on the particular day/time when determination is being made. In another example, the wireless device 102 can analyze past or current exercise activity identified (automatically or by user input) on the device (e.g., a swimming exercise, a snorkeling exercise, a free diving exercise, a scuba diving exercise, etc.). Again, it is noted that these examples are not meant to be limiting, and that the wireless device 102 can utilize any approach for effectively identifying the various states/activities discussed herein.

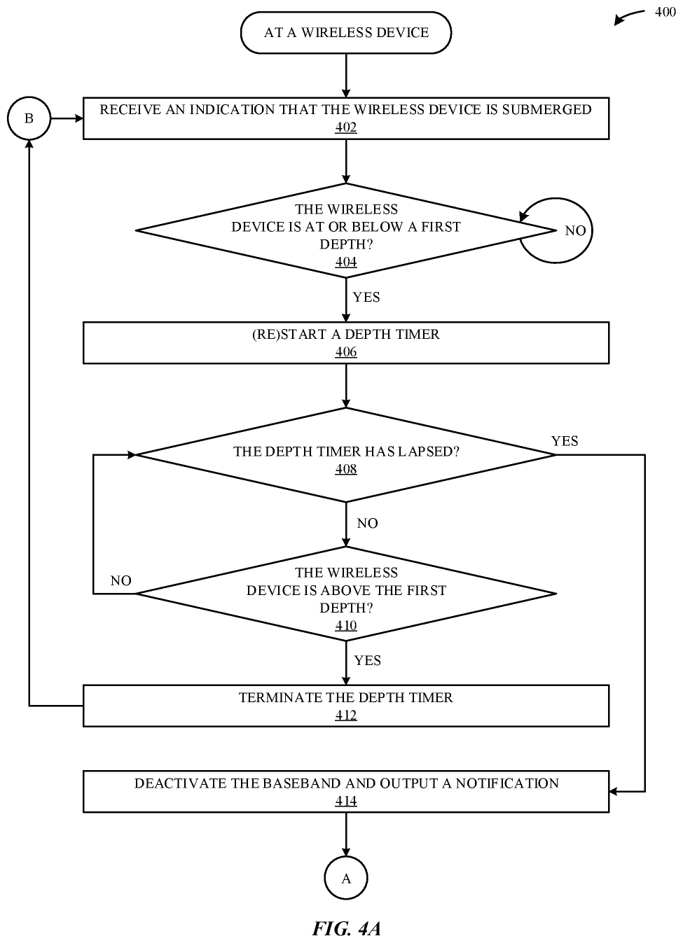

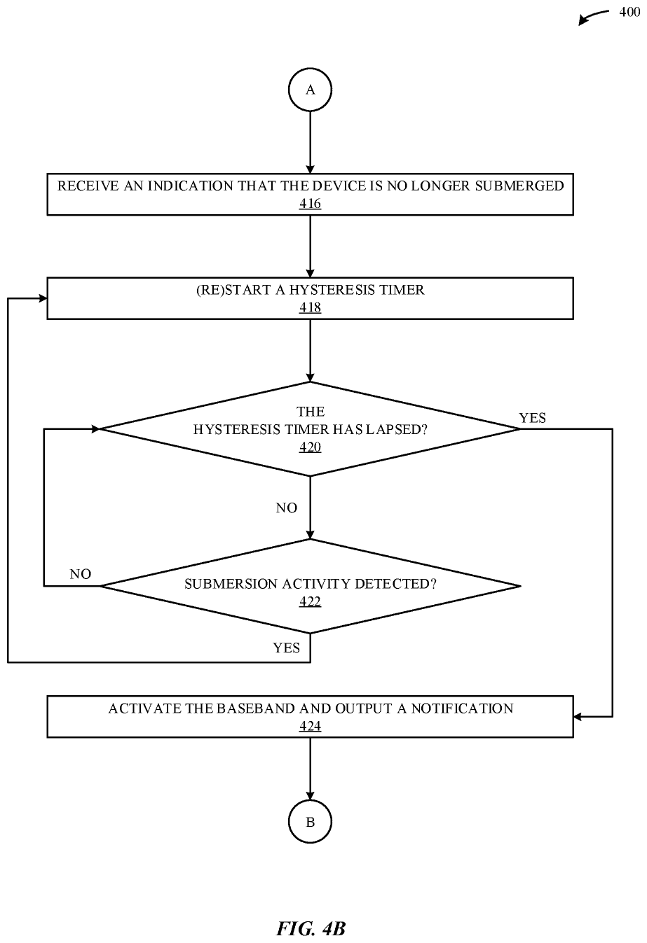

In any case, and as shown in FIG. 3, the information output by the machine learning engine 302 can be directed to a cellular connectivity manager 306. According to some embodiments, the cellular connectivity manager 306 can be configured to analyze the information output by the machine learning engine 302 and modify the cellular connectivity state of the wireless device 102 when appropriate. The details of the manner in which the machine learning engine 302 operates are described below in conjunction with FIGS. 4A, 4B, 5, and 6.

FIGS. 4A and 4B illustrate a method 400 for a technique for modifying the cellular connectivity state of a wireless device 102 when it is submerged underwater, according to some embodiments. According to some embodiments, the method 400 can be implemented by the cellular connectivity manager 306 discussed above in described above in conjunction with FIG. 3. It is noted, however, that any number of entities implemented on the wireless device 102 can assist (or supplant) the cellular connectivity manager 306 in providing the functionalities discussed herein without departing from the scope of this disclosure.

As shown in FIG. 4A, the method 400 begins at step 402, where cellular connectivity manager 306 receives an indication that the wireless device 102 is submerged underwater. The indication can be received, for example, from the machine learning engine 302 when it has effectively determined (e.g., using the techniques described above in conjunction with FIG. 3) that the wireless device 102 has entered into a body of water. It is noted that the machine learning engine 302 and/or the cellular connectivity manager 306 can disregard submersion conditions when appropriate, e.g., when they are only momentary in nature. This may occur, for example, when a user of the wireless device 102 is washing their hands, showering, etc., where an existing cellular connection (if any) would be unaffected by the temporary submersion and thus should not be modified. In any case, step 402 in FIG. 4A represents a scenario in which the wireless device 102 has reliably determined that a legitimate submersion of the wireless device 102 has occurred.

At step 404, the cellular connectivity manager 306 determines whether the wireless device 102 is at or below a first depth. According to some embodiments, the first depth can reflect a depth of submersion where physical challenges arise with respect to maintaining a cellular connection between the wireless device 102 and a base station 112. For example, if it is known that the wireless device 102 is unable to maintain a cellular connection when it is at or below a depth of three (3) feet in water, then it may be prudent to modify the cellular connectivity state of the wireless device 102 in relation to reaching such a depth. If, at step 404, the wireless device 102 determines that the wireless device 102 is at or below the first depth, then the method 400 proceeds to step 406. Otherwise, the method 400 repeats at step 404 until the wireless device 102 is at or below the first depth. It is noted that, although not illustrated at step 404 in FIG. 4A, the method 400 can also restart if the cellular connectivity manager 306 receives an indication that the wireless device 102 is no longer submerged underwater.

At step 406, the cellular connectivity manager 306 starts a depth timer. According to some embodiments, the depth timer can be implemented to avoid “thrashing” scenarios where the wireless device 102 rapidly (and unnecessarily) switches between different connectivity states in response to repeatedly rising above/below the first depth over a relatively brief period of time (e.g., a few seconds). In this regard, the depth timer effectively requires the wireless device 102 to remain at or below the first depth for a threshold period of time before any adjustments to the cellular connectivity state of the wireless device 102 are performed. In one example, the depth timer can be set to twenty (20) seconds. It is noted that the depth timer can also be dynamic in nature. In particular, the depth timer can vary based on what the wireless device 102 knows about the user and/or activity that is being performed. For example, the wireless device 102 may determine over time that its user, when engaged in surface swimming exercises (where a cellular connection, if any, should remain active), often swims the entire length of the pool below the surface at approximately three (3) feet, and that this action typically takes forty-five (45) seconds to complete. In this scenario, the depth timer could be set based on this amount of time (e.g., fifty (50) seconds) so that the wireless device 102 does not terminate its cellular connection around the time where the user is likely to imminently surface.

In any case, at step 408, the cellular connectivity manager 306 determines whether the depth timer has lapsed. Here, the term “lapsed” means that the depth timer (e.g., a count-down or count-up timer) has run for its set length of time (e.g., twenty (20) seconds). If, at step 408, the cellular connectivity manager 306 determines that the depth timer has lapsed, then the method 400 proceeds to step 414, which is described below in greater detail. Otherwise, the method 400 proceeds to step 410.

At step 410, the cellular connectivity manager 306 determines whether the wireless device 102 is above the first depth. It is noted that step 410 is part of the thrashing avoidance technique discussed above in conjunction with step 406. In particular, step 410 is implemented to determine if the wireless device 102 momentarily dipped to or below the first depth, but then ascended above the first depth prior to the threshold period of time taking place (i.e., prior to the depth timer lapsing). If, at step 410, the cellular connectivity manager 306 determines that the wireless device 102 is above the first depth, then the method 400 proceeds to step 412, where the depth timer is terminated (i.e., ended). When step 412 is executed, the method 400 proceeds back to step 402. In that regard, if there is an indication that the wireless device 102 remains submerged—but is submerged above the first depth—then the depth timer will not restart at step 406 until the wireless device 102 is at or below the first depth at step 404.

Alternatively, if, at step 410, the cellular connectivity manager 306 determines that the wireless device 102 is not above the first depth—i.e., the wireless device 102 remains at or below the first depth—then then method 400 proceeds back to step 408, where a determination is made as to whether the depth timer has lapsed (as discussed above).

Accordingly, so long as the wireless device 102 remains at or below the first depth, the depth timer will continue to advance toward lapsing. On the other hand, and as described above, if the wireless device goes above the first depth prior to the depth timer lapsing, then the depth timer is terminated, and may be restarted at step 406 depending on (1) whether the wireless device 102 is submerged, as well as (2) the current depth at which it is submerged.

Step 414 occurs when the wireless device 102 has remained at or below the threshold depth for the amount of time related to the depth timer. When step 414 occurs, the cellular connectivity manager 306 deactivates the baseband wireless circuitry 110 and outputs a notification. Deactivating the baseband wireless circuitry 110 can involve any number of approaches that effectively prevent the baseband wireless circuitry 110 from attempting to establish a cellular connection with a base station 112. For example, the power to the baseband wireless circuitry 110 can be terminated, a configuration profile of the baseband wireless circuitry 110 can be updated to prohibit it from searching for base stations 112, and the like. It is noted that the foregoing examples are not meant to be limiting, and that any approach can be utilized, at any level of granularity, to prevent the baseband wireless circuitry 110 from attempting to establish cellular connectivity until it is appropriate to do so.

At the conclusion of step 414, the wireless device 102 is operating under a state where the baseband wireless circuitry 110 is neither maintaining a cellular connection nor attempting to establish a cellular connection with the base stations 112. This operating state will remain intact so long as the wireless device 102 remains submerged underwater. However, appropriate measures should be taken to attempt to restore cellular connectivity when the wireless device 102 is no longer submerged, the details of which are discussed below in conjunction with steps 416-424.

Turning now to FIG. 4B, at step 416, cellular connectivity manager 306 receives an indication that the device is no longer submerged. The indication can be received, for example, from the machine learning engine 302 when it has effectively determined (e.g., using the techniques described above in conjunction with FIG. 3) that the wireless device 102 has reached the surface of a body of water. It is noted that the machine learning engine 302 and/or the cellular connectivity manager 306 can disregard surfacing conditions when appropriate, e.g., when they are only momentary in nature. This may occur, for example, when a user of the wireless device 102 is engaged in free diving exercises and periodically surfaces for a brief moment to inhale air. In any case, step 416 in FIG. 4A takes place when the wireless device 102 has reliably determined that a legitimate surfacing of the wireless device 102 has occurred.

At step 418, the cellular connectivity manager 306 starts a hysteresis timer. According to some embodiments, the hysteresis timer, like the depth timer, can be implemented to avoid “thrashing” scenarios where the wireless device 102 rapidly (and unnecessarily) switches between different connectivity states in response to repeatedly rising above/below the surface over a relatively brief period of time (e.g., a few seconds). In this regard, the hysteresis timer effectively requires the wireless device 102 to remain above the surface (i.e., unsubmerged) for a threshold period of time before any adjustments to the cellular connectivity state of the wireless device 102 are performed. In one example, the hysteresis timer can be set to four (4) seconds. It is noted that the hysteresis timer, like the depth timer, can also be dynamic in nature and based on what the wireless device 102 knows about the user and/or activity that is being performed.

In any case, at step 420, the cellular connectivity manager 306 determines whether the hysteresis timer has lapsed. According to some embodiments, the hysteresis timer can be implemented as a count-up or a count-down timer that terminates when the amount of time assigned to the hysteresis timer lapses. Again, the term “lapsed” means that the hysteresis timer has run for its set length of time (e.g., four (4) seconds). According to some embodiments, the hysteresis timer can also be configured to reset (i.e., restart) when one or more conditions are satisfied. In any case, if, at step 420, the cellular connectivity manager 306 determines that the hysteresis timer has lapsed, then the method 400 proceeds to step 424, which is discussed below in greater detail. Otherwise, the method 400 proceeds to step 422.

At step 422, the cellular connectivity manager 306 determines whether submersion activity is detected. This can occur, for example, when a user of the wireless device 102 temporarily resurfaces and then plunges back into the water, where it would be imprudent to activate the baseband wireless circuitry 110 in that moment of time. If, at step 422, the cellular connectivity manager 306 detects submersion activity, then the method 400 proceeds to step 418, where the hysteresis timer is restarted. Steps 420-422 are then repeated until no submersion activity is detected through the length of the hysteresis timer. Otherwise, if no submersion activity is detected at step 422, then the hysteresis timer continues to run, and the method 400 proceeds back to step 420 to determine whether the hysteresis timer has lapsed.

Ultimately, when the hysteresis timer has lapsed—which means the wireless device 102 has remained at the surface for the period of time related to the hysteresis timer—the method 400 proceeds to step 424, where the cellular connectivity manager 306 activates the baseband wireless circuitry 110 and outputs a notification. Activating the baseband wireless circuitry 110 can involve any number of approaches that effectively enable/permit the baseband wireless circuitry 110 to attempt to establish a cellular connection with a base station 112. For example, the power to the baseband wireless circuitry 110 can be restored, a configuration profile of the baseband wireless circuitry 110 can be updated (to permit it to search for base stations 112), and the like. It is noted that the foregoing examples are not meant to be limiting, and that any approach can be utilized, at any level of granularity, to enable/permit the baseband wireless circuitry 110 to attempt to establish cellular connectivity when it is appropriate to do so.

Additionally, and although not illustrated in FIGS. 4A-4B, it is noted that the various aquatic activities described herein that are detectable by the cellular connectivity manager 306 can influence the manner in which the method 400 is implemented. For example, at step 402, the cellular connectivity manager 306 can (in conjunction with receiving the indication that the wireless device 102 is submerged) wait until it receives one or more additional indications that some form of aquatic activity is (or is not) taking place. This approach could be beneficial in that it would bolster the overall confidence of the cellular connectivity manager 306 that the wireless device 102 is in fact submerged underwater and that an activity is taking place where a cellular connection is not needed and/or is not physically possible. Alternatively, the cellular connectivity manager 306 could omit (or add) steps to the method 400 based on the type of activity that is detected.

In another example, the cellular connectivity manager 306 could modify the various timers and depths discussed in this disclosure based on the type of aquatic activity that is detected. For example, the depth thresholds and timers could be modified to account for surface-based aquatic activities when swimming and snorkeling activities are detected. Conversely, the depth thresholds and timers could be modified to account for subsurface-based aquatic activities when free diving and scuba diving activities are detected.

In yet another example, at step 416, the cellular connectivity manager 306 (in conjunction with receiving the indication that the wireless device 102 is no longer submerged) wait until it receives one or more additional indications that some form of aquatic activity is (or is not) taking. This can be beneficial, for example, when a scuba dive has just ended but the user is swimming across the surface of the body of water for some time until the user is able to exit the water (e.g., onto a beach, a dock, a boat, etc.). In this scenario, it may be unnecessary for the wireless device 102 to reactivate its cellular connection given it is unlikely the user will be utilizing internet-based services on wireless device 102 while swimming to a destination.

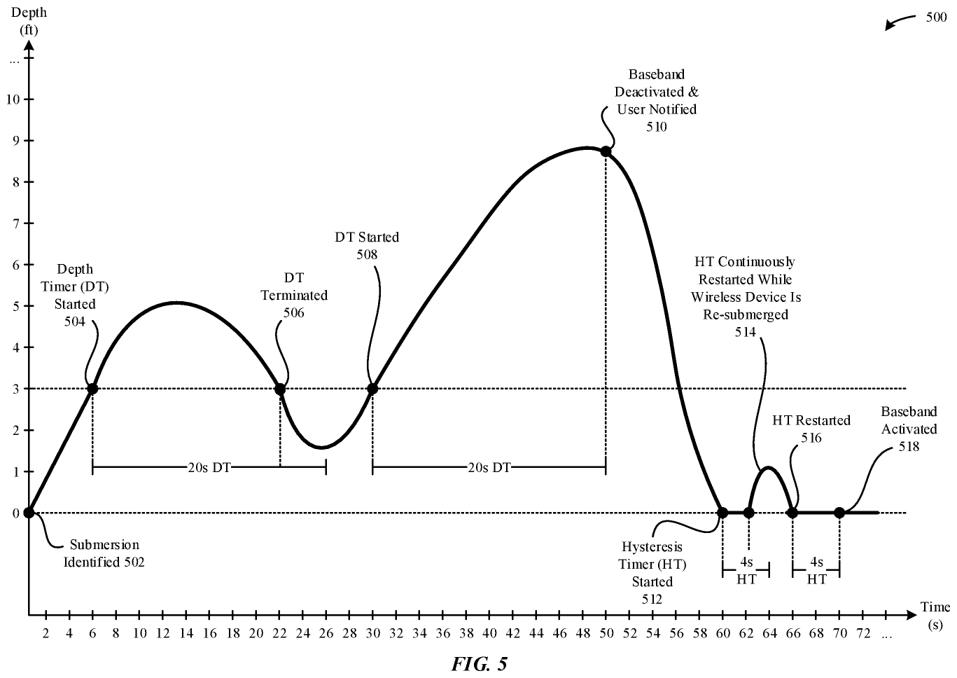

Accordingly, FIGS. 4A and 4B set forth a technique for modifying the cellular connectivity state of a wireless device 102 when it is submerged underwater, according to some embodiments. An example scenario of when and how this technique can be implemented is described below in conjunction with FIG. 5.

FIG. 5 sets forth a conceptual diagram of an example scenario 500 that involves a wireless device 102 undergoing cellular connectivity state modifications in relation to exemplary aquatic activity in which a user of the wireless device 102 is engaging, according to some embodiments. As shown in FIG. 5, an incident 502 involves the cellular connectivity manager 306 identifying that the wireless device 102 has been submerged underwater. This incident relates to step 402 discussed above in conjunction with FIG. 4A. As shown in FIG. 5, when the wireless device 102 is initially submerged underwater, no modifications to the cellular connectivity state of the wireless device 102 are performed because the wireless device 102, despite being submerged, has not yet reached the threshold depth (which, in FIG. 5, is set at a depth of three (3) feet). This period of time relates to step 404 discussed above in conjunction with FIG. 4A.

Continuing on in FIG. 5, an incident 504 takes place when the cellular connectivity manager 306 determines that the wireless device 102 is at or below the threshold depth. This incident relates to step 404 discussed above in conjunction with FIG. 4A. As shown in FIG. 5, the incident 504 involves starting a depth timer set at twenty (20) seconds. This incident relates to step 406 discussed above in conjunction with FIG. 4A. As previously discussed herein, the depth timer effectively requires the wireless device 102 to remain at or below the threshold depth for at least twenty (20) seconds prior to modifying the cellular connectivity state of the wireless device 102. This period of time relates to steps 408-410 discussed above in conjunction with FIG. 4A.

Continuing on in FIG. 5, an incident 506 takes place when the cellular connectivity manager 306 determines that the wireless device 102 has ascended above the threshold depth prior to the depth timer lapsing (at sixteen (16) seconds, not the twenty (20) seconds required by the depth timer). In turn, and accordingly, the depth timer is terminated, and remains inactive until the wireless device 102 descends to or below the threshold depth again. This incident relates to step 412 discussed above in conjunction with FIG. 4A.

Continuing on in FIG. 5, after the incident 506 takes place, the wireless device 102 continues to ascend for approximately four (4) seconds, and then begins to descend for another four seconds until it reaches the threshold depth of three feet, at which point incident 508 takes place. As shown in FIG. 5, incident 508 can involve restarting the depth timer (i.e., at twenty (20) seconds). Again, this incident relates to step 406 discussed above in conjunction with FIG. 4A.

As shown in FIG. 5, after the depth timer is restarted at incident 508, the wireless device 102 continues to descend to greater depths—for at least a period of twenty (20) seconds—such that there is no threshold depth violation that otherwise would cause the depth timer to be terminated. This period of time relates to steps 408-410 discussed above in conjunction with FIG. 4A. Accordingly, an incident 510 occurs after the depth timer lapses, at which point the cellular connectivity manager 306 deactivates the baseband wireless circuitry 110 (e.g., using any number of the approaches discussed herein). This incident relates to step 414 discussed above in conjunction with FIG. 4A.

After the baseband wireless circuitry 110 is deactivated in conjunction with incident 510, the wireless device 102 begins to ascend toward the service over a ten second period until it reaches a depth of zero (0) feet and is no longer (or is only partially/intermittently) submerged. This incident relates to step 416 discussed above in conjunction with FIG. 4B. At this juncture, however, no modifications to the cellular connectivity state of the wireless device 102 are performed because the wireless device 102, despite being at the surface, has yet to remain at the service for a period of time that is satisfactory. Accordingly, an incident 512 can involve the cellular connectivity manager 306 starting a hysteresis timer—which, in FIG. 5, is set at four (4) seconds. This incident relates to step 418 discussed above in conjunction with FIG. 4B.

Continuing on in FIG. 5, after the hysteresis timer is started, the wireless device 102 remains at or around the surface of the water for approximately two (2) seconds, but suddenly begins to descend approximately one (1) foot below the surface over a two (2) second period. This period of time is represented by incident 514 in FIG. 5, where the hysteresis timer is continuously restarted so long as the wireless device 102 remains in violation of the hysteresis timer by not remaining at the surface of the water. This period of time relates to steps 418-422 discussed above in conjunction with FIG. 4B.

Ultimately, an incident 516 involves a restart of the hysteresis timer in conjunction with the wireless device 102 reaching the surface of the water. As shown in FIG. 5, the wireless device 102 remains at the surface of the water for the four (4) second threshold required by the hysteresis timer, thereby enabling the hysteresis timer to lapse. This incident relates to step 420 discussed above in conjunction with FIG. 4B. Accordingly, and at incident 518 in FIG. 5, the cellular connectivity manager 306 activates the baseband wireless circuitry 110 (e.g., using any of the techniques described herein).

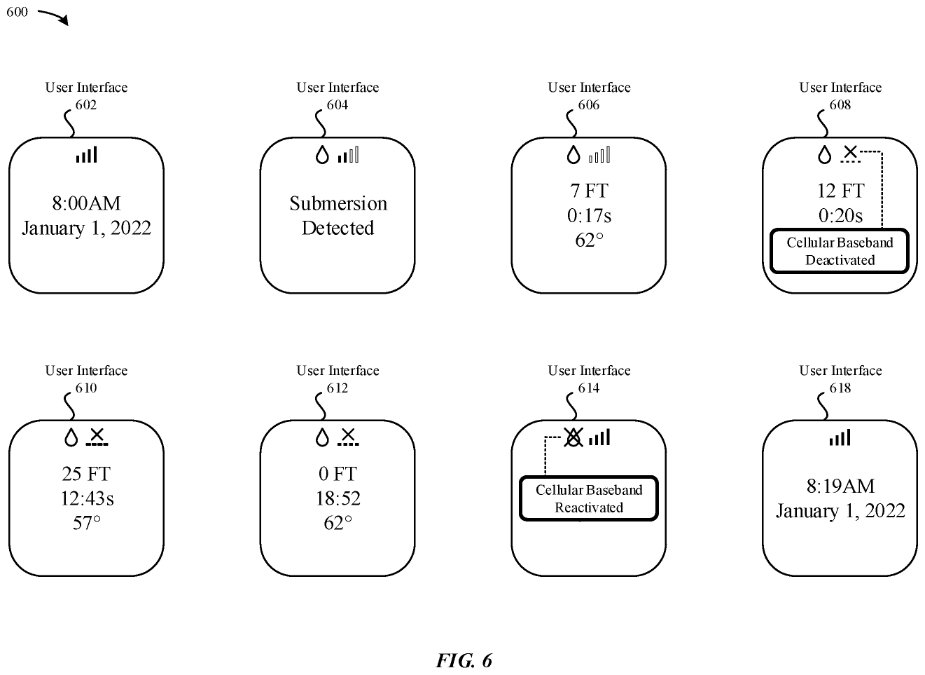

Accordingly, FIG. 5 sets forth a conceptual diagram of an example scenario under which a given wireless device 102 can undergo cellular connectivity state modifications in relation to aquatic activity in which a user of the wireless device 102 is engaging, according to some embodiments. Additionally, FIG. 6 provides exemplary user interfaces that can be implemented in order to provide valuable feedback to the user so that they remain apprised of (and not confused by) the automated cellular connectivity state adjustments that take place in relation to their aquatic activities.

FIG. 6 illustrates a conceptual diagram 600 of exemplary user interfaces that can be displayed by a wireless device 102 that is undergoing cellular connectivity state modifications in relation to aquatic activity in which a user of the wireless device 102 is engaging, according to some embodiments.

As shown in FIG. 6, the wireless device 102 can initially display a user interface 602, which can constitute, for example, a lock screen or a welcome screen of the wireless device 102. As shown in FIG. 6, the user interface 602 includes a number of bars that indicate both an active cellular connection as well as an overall strength of the cellular connection.

A user interface 604 can be displayed by the wireless device 102 when the cellular connectivity manager 306 receives an indication that the wireless device 102 has been submerged underwater (e.g., as described above in conjunction with step 402 of FIG. 4A). As shown in FIG. 6, the user interface 604 continues to display information about the cellular connection despite being submerged (given the depth threshold (e.g., three (3) feet)/depth timer (e.g., twenty (20) seconds) discussed herein have not been satisfied/lapsed, and thus the cellular connectivity state of the wireless device 102 remains unmodified). However, due to the submersion, the cellular connection strength likely will have dropped, which is indicated by the decreased number of bars in the user interface 604. The user interface can also display a water droplet icon indicating that the wireless device 102 has entered into a submerged mode.

As shown in FIG. 6, a user interface 606 represents a point in time where the wireless device 102 is at a depth of seven (7) feet and has been submerged at three (3) or more feet for seventeen (17) seconds. In this regard, although the depth threshold has been satisfied, the depth timer has not yet lapsed, so the cellular connection remains active. However, due to increased depth, the cellular connection likely will have dropped, which is indicated by the lack of bars in the user interface 606.

Next, and as shown in FIG. 6, a user interface 608 represents a point in time where the wireless device 102 is at a depth of twelve (12) feet and has been submerged at three (3) or more feet for twenty (20) seconds. In this regard, the depth threshold has been satisfied and the depth timer has lapsed, which gives rise to a condition where it is appropriate to modify the cellular connectivity state of the wireless device 102. Accordingly, and as shown in the user interface 608, the cellular connection is terminated (as indicated by an “X” through the cellular reception bars), and a notification is provided to the user indicating that the baseband wireless circuitry 110 has been deactivated.

Next, and as shown in FIG. 6, a user interface 610 represents a moment in time where the user/wireless device 102 have remained submerged underwater for twelve (12) minutes and forty-three (43) seconds. In this regard, the baseband wireless circuitry 110 has remained deactivated such that the wireless device 102 has not expended any resources attempting to reestablish a connection to a base station 112 (where it would be futile to do so given the physical limitations imposed by the depth).

Next, and as shown in FIG. 6, a user interface 612 represents a moment in time where the user/wireless device 102 have ascended to and reached the surface of the water after eighteen (18) minutes and fifty-two (52) seconds. Accordingly, a next user interface 614 is displayed, which indicates that the submerged mode is no longer active (as indicated by the “X” through the water droplet icon) and that a cellular connection has been restored. The user interface 614 can also provide a notification to inform the user that baseband wireless circuitry 110 has been reactivated. In turn, the wireless device 102 can display a user interface 618, such as a lock screen or home screen, after the user has concluded the submerged activity and a cellular connection has been restored.

It is noted that the user interfaces illustrated in FIG. 6 (and described herein) are merely exemplary and not meant to be limiting in any fashion. On the contrary, any number of user interfaces can be implemented to effectively inform the user of the various issues and procedures described throughout this disclosure without departing from its scope.

Additionally, it is noted that the different values assigned to the various timers, depth thresholds, etc., discussed herein are merely exemplary and not meant to be limiting. On the contrary, any values, at any level of granularity, can be assigned to the timers/depth thresholds without departing from the scope of this disclosure. Additionally, it is noted that the number of timers/depth thresholds discussed herein are merely exemplary and not meant to be limiting. On the contrary, any number of timers/depth thresholds (or other conditional control mechanisms) can be implemented to provide finer (or coarser) granularities of control over the manner in which the wireless device 102 modifies its cellular connection state. For example, multiple cellular connection states could be implemented, where the wireless device progressively enters into (or exits from) the different connection states in accordance with different conditions that apply. For example, the overall amount of power supplied to the baseband and/or the number of reconnection attempts performed by the baseband could be iteratively increased as the wireless device satisfies decreases in depth that indicate a likelihood of surfacing (and vice-versa). Again, it is noted that these examples are not meant to be limiting, and that any number of connection states can be implemented, at any level of granularity, without departing from the scope of this disclosure.

Finally, it is noted that the various techniques provided herein can be overridden by a user at any time regardless of state in which the wireless device 102 is operating. For example, when the wireless device 102 determines that it is prudent to deactivate the baseband, the user can still cause the baseband to be reactivated such that the wireless device 102 begins searching for a base station. This can be particularly useful in emergency situations where the user should be ignored or overridden when the user would be benefit from the possibility of the wireless device 102 successfully connecting to a base station.

### Exemplary Embodiments

In an exemplary embodiments, a method for managing a cellular connectivity state of a wireless device in relation to aquatic activity performed using the wireless device includes: i) determining that the wireless device is submerged underwater; ii) in response to determining that the wireless device satisfies a threshold depth, starting a depth timer, where the wireless device a) terminates the depth timer whenever the wireless device no longer satisfies the threshold depth, and b) restarts the depth timer whenever the wireless device satisfies the threshold depth after the depth timer is terminated; and iii) in response to identifying that the depth timer has lapsed, deactivating a baseband component of the wireless device to prevent the baseband component from attempting to establish a cellular connection.

In some embodiments, the method further includes the wireless device, subsequent to deactivating the baseband component: i) determining that the wireless device is no longer submerged underwater; ii) starting a hysteresis timer, where the wireless device restarts the hysteresis timer whenever the wireless device becomes re-submerged underwater; and iii) in response to identifying that the hysteresis timer has lapsed, activating the baseband component of the wireless device to enable the baseband component to establish the cellular connection. In some embodiments, determination that the wireless device is submerged underwater includes analyzing information that includes at least one of: motion information, sound information, pressure information, light information, moisture information, temperature information, or location information. In some embodiments, the wireless device analyzes the information by at least providing the information to a machine learning engine that has been trained at least in part using prior information gathered from wireless devices in relation to being submerged underwater and/or being involved in aquatic activity, and the machine learning engine indicates whether the wireless device is submerged underwater. In some embodiments, the machine learning engine further indicates whether a user of the wireless device is engaged in an activity that includes at least one of: a swimming activity, a snorkeling activity, a free diving activity, or a scuba diving activity. In some embodiments, the threshold depth, the depth timer, and/or the hysteresis timer are assigned respective values based on the activity. In some embodiments, the wireless device includes a wearable wireless device that is waterproof or water resistant.

### Exemplary Computing Device

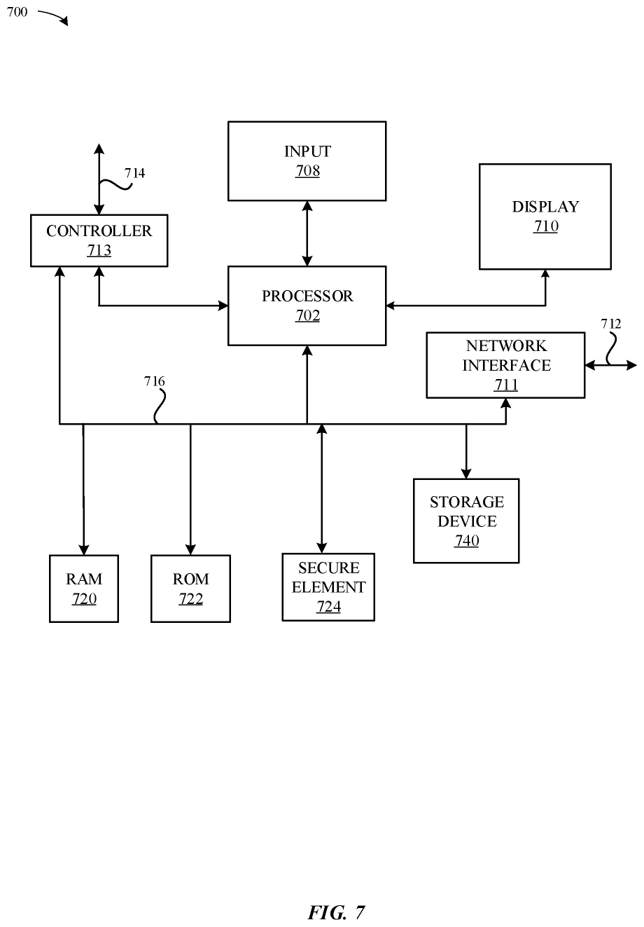

FIG. 7 illustrates a detailed view of a representative computing device 700 that can be used to implement various methods described herein, according to some embodiments. In particular, the detailed view illustrates various components that can be included in a wireless device 102. As shown in FIG. 7, the computing device 700 can include a processor 702 that represents a microprocessor or controller for controlling the overall operation of computing device 700. The computing device 700 can also include a user input device 708 that allows a user of the computing device 700 to interact with the computing device 700. For example, the user input device 708 can take a variety of forms, such as a button, keypad, dial, touch screen, audio input interface, visual/image capture input interface, input in the form of sensor data, etc. Still further, the computing device 700 can include a display 710 that can be controlled by the processor 702 to display information to the user. A data bus 716 can facilitate data transfer between at least a storage device 740, the processor 702, and a controller 713. The controller 713 can be used to interface with and control different equipment through an equipment control bus 714. The computing device 700 can also include a network/bus interface 711 that communicatively couples to a data link 712. In the case of a wireless connection, the network/bus interface 711 can include a wireless transceiver.

The computing device 700 also includes a storage device 740, which can comprise a single disk or a plurality of disks (e.g., hard drives), and includes a storage management module that manages one or more partitions within the storage device 740. In some embodiments, storage device 740 can include flash memory, semiconductor (solid state) memory or the like. The computing device 700 can also include a Random Access Memory (RAM) 720 and a Read-Only Memory (ROM) 722. The ROM 722 can store programs, utilities, or processes to be executed in a non-volatile manner. The RAM 720 can provide volatile data storage, and stores instructions related to the operation of the computing device 700. The computing device 700 can further include a secure element (SE) 724, such as an eUICC 108, a UICC 118, or another secure storage for cellular wireless system access by a wireless device 102.

### Wireless Terminology

In accordance with various embodiments described herein, the terms “wireless communication device,” “wireless device,” “mobile wireless device,” “mobile station,” and “user equipment” (UE) may be used interchangeably herein to describe one or more common consumer electronic devices that may be capable of performing procedures associated with various embodiments of the disclosure. In accordance with various implementations, any one of these consumer electronic devices may relate to: a cellular phone or a smart phone, a tablet computer, a laptop computer, a notebook computer, a personal computer, a netbook computer, a media player device, an electronic book device, a MiFi® device, a wearable computing device, as well as any other type of electronic computing device having wireless communication capability that can include communication via one or more wireless communication protocols such as used for communication on: a wireless wide area network (WWAN), a wireless metro area network (WMAN) a wireless local area network (WLAN), a wireless personal area network (WPAN), a near field communication (NFC), a cellular wireless network, a fourth generation (4G) Long Term Evolution (LTE), LTE Advanced (LTE-A), and/or 5G or other present or future developed advanced cellular wireless networks.

The wireless communication device, in some embodiments, can also operate as part of a wireless communication system, which can include a set of client devices, which can also be referred to as stations, client wireless devices, or client wireless communication devices, interconnected to an access point (AP), e.g., as part of a WLAN, and/or to each other, e.g., as part of a WPAN and/or an “ad hoc” wireless network. In some embodiments, the client device can be any wireless communication device that is capable of communicating via a WLAN technology, e.g., in accordance with a wireless local area network communication protocol. In some embodiments, the WLAN technology can include a Wi-Fi (or more generically a WLAN) wireless communication subsystem or radio, the Wi-Fi radio can implement an Institute of Electrical and Electronics Engineers (IEEE) 802.11 technology, such as one or more of: IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies.

Additionally, it should be understood that the UEs described herein may be configured as multi-mode wireless communication devices that are also capable of communicating via different third generation (3G) and/or second generation (2G) RATs. In these scenarios, a multi-mode UE can be configured to prefer attachment to LTE networks offering faster data rate throughput, as compared to other 3G legacy networks offering lower data rate throughputs. For instance, in some implementations, a multi-mode UE may be configured to fall back to a 3G legacy network, e.g., an Evolved High-Speed Packet Access (HSPA+) network or a Code Division Multiple Access (CDMA) 2000 Evolution-Data Only (EV-DO) network, when LTE and LTE-A networks are otherwise unavailable.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

Regarding the present disclosure, it is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for managing a cellular connectivity state of a wireless device in relation to aquatic activity performed using the wireless device, the method comprising, at the wireless device:
determining that the wireless device is submerged underwater;
in response to determining that the wireless device satisfies a threshold depth:
starting a depth timer, wherein the wireless device:
terminates the depth timer whenever the wireless device no longer satisfies the threshold depth, and
restarts the depth timer whenever the wireless device satisfies the threshold depth after the depth timer is terminated; and
in response to identifying that the depth timer has lapsed:
deactivating a baseband component of the wireless device to prevent the baseband component from attempting to establish a cellular connection.

2. The method of claim 1, further comprising, subsequent to deactivating the baseband component:
determining that the wireless device is no longer submerged underwater;
starting a hysteresis timer, wherein the wireless device restarts the hysteresis timer whenever the wireless device becomes re-submerged underwater; and
in response to identifying that the hysteresis timer has lapsed:
activating the baseband component of the wireless device to enable the baseband component to establish the cellular connection.

3. The method of claim 2, wherein determining that the wireless device is submerged underwater comprises analyzing information that includes at least one of:
motion information,
sound information,
pressure information,
light information,
moisture information,
temperature information, or
location information.

4. The method of claim 3, wherein:
analyzing the information comprises providing the information to a machine learning engine that has been trained at least in part using prior information gathered from wireless devices in relation to being submerged underwater and/or being involved in aquatic activity, and
the machine learning engine indicates whether the wireless device is submerged underwater.

5. The method of claim 4, wherein the machine learning engine further indicates whether a user of the wireless device is engaged in an activity that includes at least one of:
a swimming activity,
a snorkeling activity,
a free diving activity, or
a scuba diving activity.

6. The method of claim 5, wherein the threshold depth, the depth timer, and/or the hysteresis timer are assigned respective values based on the activity.

7. The method of claim 1, wherein the wireless device comprises a wearable wireless device that is waterproof or water resistant.

8. A non-transitory computer readable storage medium configured to store instructions that, when executed by a processor included in a wireless device, cause the wireless device to manage a cellular connectivity state of the wireless device in relation to aquatic activity performed using the wireless device, by carrying out steps that include:
determining that the wireless device is submerged underwater;
in response to determining that the wireless device satisfies a threshold depth:
starting a depth timer, wherein the wireless device:
terminates the depth timer whenever the wireless device no longer satisfies the threshold depth, and
restarts the depth timer whenever the wireless device satisfies the threshold depth after the depth timer is terminated; and
in response to identifying that the depth timer has lapsed:
deactivating a baseband component of the wireless device to prevent the baseband component from attempting to establish a cellular connection.

9. The non-transitory computer readable storage medium of claim 8, wherein the steps further include, subsequent to deactivating the baseband component:
determining that the wireless device is no longer submerged underwater;
starting a hysteresis timer, wherein the wireless device restarts the hysteresis timer whenever the wireless device becomes re-submerged underwater; and
in response to identifying that the hysteresis timer has lapsed:
activating the baseband component of the wireless device to enable the baseband component to establish the cellular connection.

10. The non-transitory computer readable storage medium of claim 9, wherein determining that the wireless device is submerged underwater comprises analyzing information that includes at least one of:
motion information,
sound information,
pressure information,
light information,
moisture information,
temperature information, or
location information.

11. The non-transitory computer readable storage medium of claim 10, wherein:
analyzing the information comprises providing the information to a machine learning engine that has been trained at least in part using prior information gathered from wireless devices in relation to being submerged underwater and/or being involved in aquatic activity, and
the machine learning engine indicates whether the wireless device is submerged underwater.

12. The non-transitory computer readable storage medium of claim 11, wherein the machine learning engine further indicates whether a user of the wireless device is engaged in an activity that includes at least one of:
a swimming activity,
a snorkeling activity,
a free diving activity, or
a scuba diving activity.

13. The non-transitory computer readable storage medium of claim 12, wherein the threshold depth, the depth timer, and/or the hysteresis timer are assigned respective values based on the activity.

14. The non-transitory computer readable storage medium of claim 8, wherein the wireless device comprises a wearable wireless device that is waterproof or water resistant.

15. A wireless device configured to manage a cellular connectivity state of the wireless device in relation to aquatic activity performed using the wireless device, the wireless device comprising a processor configured to cause the wireless device to carry out steps that include:
determining that the wireless device is submerged underwater;
in response to determining that the wireless device satisfies a threshold depth:
starting a depth timer, wherein the wireless device:
terminates the depth timer whenever the wireless device no longer satisfies the threshold depth, and
restarts the depth timer whenever the wireless device satisfies the threshold depth after the depth timer is terminated; and
in response to identifying that the depth timer has lapsed:
deactivating a baseband component of the wireless device to prevent the baseband component from attempting to establish a cellular connection.

16. The wireless device of claim 15, wherein the steps further include, subsequent to deactivating the baseband component:
determining that the wireless device is no longer submerged underwater;
starting a hysteresis timer, wherein the wireless device restarts the hysteresis timer whenever the wireless device becomes re-submerged underwater; and
in response to identifying that the hysteresis timer has lapsed:
activating the baseband component of the wireless device to enable the baseband component to establish the cellular connection.

17. The wireless device of claim 16, wherein determining that the wireless device is submerged underwater comprises analyzing information that includes at least one of:
motion information,
sound information,
pressure information,
light information,
moisture information,
temperature information, or
location information.

18. The wireless device of claim 17, wherein:
analyzing the information comprises providing the information to a machine learning engine that has been trained at least in part using prior information gathered from wireless devices in relation to being submerged underwater and/or being involved in aquatic activity, and
the machine learning engine indicates whether the wireless device is submerged underwater.

19. The wireless device of claim 18, wherein the machine learning engine further indicates whether a user of the wireless device is engaged in an activity that includes at least one of:
a swimming activity,
a snorkeling activity,
a free diving activity, or
a scuba diving activity.

20. The wireless device of claim 19, wherein the threshold depth, the depth timer, and/or the hysteresis timer are assigned respective values based on the activity.
